(19) United States
(12) Patent Application Publication
(10) Pub. No.: US 2004/0217574 A1
(43) Pub. Date: Nov. 4, 2004

(54) Rear suspension

(76) Inventors: Yoshiyuki Horii, Saitama (JP); Yukinori Kurakawa, Saitama (JP); Takashi Kudo, Saitama (JP)

Correspondence Address: BIRCH STEWART KOLASCH & BIRCH, PO BOX 747, FALLS CHURCH, VA, 22040-0747, US

(21) Appl. No.: 10/777,749

(22) Filed: Feb. 13, 2004

(30) Foreign Application Priority Data
Feb. 21, 2003 (JP) 2003-044877

(51) Int. Cl. B62K 11/00

(52) U.S. Cl. 280/284

(57) ABSTRACT

To secure minimum road clearance by heightening the position of a link coupled to the lower end of a rear cushion and to sufficiently lengthen a damper and a cushion spring. A rear cushion includes a damper and a cushion spring. The lower end of each of the piston rod and the cushion spring is supported by a cylindrical cushion holder having a bottom. A first link is linked with the side of the cushion holder via a shaft. Other parts of the first link are linked with a stay of a pivot frame and a second link via respective shafts. The rear end of the second link is linked with the side of a rear swing arm via a shaft and the upper end of the rear cushion is supported by the pivot frame via a bridge.

### CROSS-REFERENCE TO RELATED APPLICATIONS

This nonprovisional application claims priority under 35 U.S.C. §119(a) on Patent Application No. 2003-044877, filed in Japan on Feb. 21, 2003, the entirety of which is incorporated herein by reference.

### BACKGROUND OF THE INVENTION

1. Field of the Invention

The present invention relates to a rear suspension in a motorcycle and other two-wheeled vehicles.

2. Description of Background Art

A link mechanism in a rear suspension of a motorcycle is provided with a first link having one end supported by the side of a body frame and a second link having one end supported by the side of a rear swing arm, for example, an intermediate part of the first link is coupled to a coupling part provided on the lower end of a shock absorber and the other end is coupled to the other end of the second link.

There is also a link mechanism in which the side of the upper end of a damper is supported by the side of a rear swing arm and the side of the lower end is coupled to the side of a body frame via a link as in the above-mentioned background art (for example, JP-A-2002-302086).

The lower end of the shock absorber extends downward and the end of the shock absorber is coupled to the link in the above-mentioned examples. Accordingly, the position of the link becomes low and it is difficult to secure a minimum road clearance of the body. When the lower end of the shock absorber is simply lifted upward, the minimum road clearance can be secured; however, since the height of the side of the upper end is limited in terms of the layout of the body and the upper end cannot be freely heightened, the length of the shock absorber must be reduced. Accordingly, in order to ensure that the performance of the shock absorber is satisfactory, it is required to lengthen the shock absorber to some extent.

In the meantime, as in the above-mentioned JP-A-2002-302086, when the side of a shock absorber is supported, a position in which the upper end of the shock absorber is attached can be equalized. However, the side of a damper is supported in the above-mentioned document and simultaneously, the upper end of a cushion spring is received. Accordingly, the damper can be lengthened; however, the cushion spring cannot be lengthened. Therefore, to enhance the performance of the shock absorber, it is desired to lengthen both the damper and the cushion spring. The object of the present invention is to ensure a minimum road clearance and to lengthen both the damper and the cushion spring.

### SUMMARY OF THE INVENTION

To solve the above problems, a rear suspension according to the present invention is based upon a rear suspension provided with a rear swing arm the front end of which is coupled to a body frame so that the front end can be rocked and the rear end of which supports a rear wheel. A shock absorber is provided between the rear swing arm and the body frame via a link and is characterized in that the shock absorber is provided with a damper, a cushion spring and a cushion holder covering the outside of the cushion spring and one end of the link is coupled to the side of the cushion holder.

The cushion holder can be arranged at either of the upper end or the lower end of the shock absorber. The upper end of the shock absorber may be also coupled to the rear swing arm and the lower end of the shock absorber may be also coupled to the body frame via the link.

The position of the link can be shifted upward by attaching one end of the link to the side of the cushion holder. Since the cushion holder is a member for covering the side of the cushion spring, the cushion spring and the damper can be lengthened.

At this time, if the upper end of the shock absorber is coupled to the rear swing arm, the cushion holder is provided to the lower end of the shock absorber and the cushion holder is coupled to the body frame via the link, a position in which the link is attached can be heightened, compared with a position in the background arrangement. Accordingly, sufficient minimum road clearance can be secured.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a side view illustrating an entirety of a motorcycle having the rear suspension according to the present invention;

FIG. 2 is a side view illustrating internal structure such as a body frame and an engine of the motorcycle having the rear suspension according to the present invention;

FIG. 3 is an enlargement of a main part of FIG. 2;

FIG. 4 is an enlarged side view illustrating a rear suspension;

FIG. 5 is a side view illustrating a cushion holder;

FIG. 6 illustrates the cushion holder viewed from a direction different by 90° from the cushion holder shown in FIG. 5;

FIG. 7 is a plan view illustrating the cushion holder;

FIG. 8 is a side view illustrating a first link;

FIG. 9 is a plan illustrating the first link; and

FIG. 10 is a side view illustrating a second link.

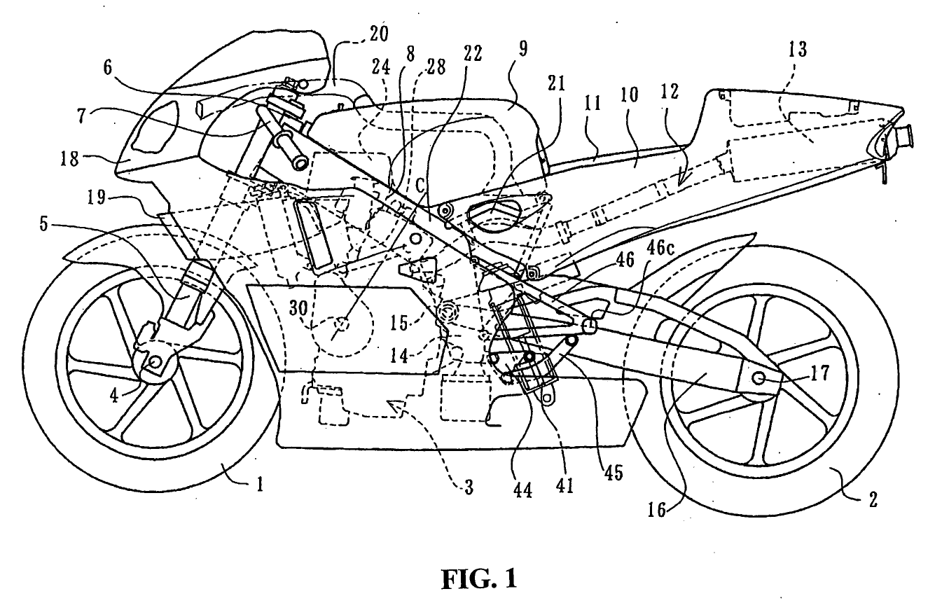

### DETAILED DESCRIPTION OF THE PREFERRED EMBODIMENTS

The present invention will now be described with reference to the accompanying drawings, wherein the same or similar elements are identified with the same reference numerals.

In the drawings, a motorcycle is illustrated as a sport motorcycle having a large displacement in which a 4-cycle in-line 4-cylinder engine 3 is arranged between a front wheel 1 and a rear wheel 2. The front wheel 1 is supported by a lower end of a front fork 5 via a front axle 4. The upside of the front fork 5 is rotatably coupled to a head pipe 6 and can be steered by a handlebar 7. The head pipe 6 is provided on the front end of a body frame 8. A fuel tank 9 is supported on the body frame 8 and an engine 3 is supported on the downside. A rear cowl 10 extending diagonally upward and backward from the rear of the body frame 8 is provided at the back of the fuel tank 9 and a seat 11 is attached to the rear cowl.

An exhaust pipe 12 extends longitudinally and a muffler 13 is connected to a rear end thereof. The exhaust pipe 12 and the muffler 13 are arranged on the inside of the rear cowl 10. The front end of a rear swing arm 16 is supported by a pivot frame 14 formed in the rear of the body frame 8 at a pivot point 15 so that the rear swing arm can be rocked. A rear axle 17 supports the rear end of the rear swing arm 16 so that the rear wheel 2 can be rotated.

The front of the body is covered with a front cowl 18. The front cowl 18 covers the front of the head pipe 6 and the engine 3 and the left and right sides of the body including the body frame 8 and the engine 3. A reference numeral 19 denotes an intake duct. A pair of intake ducts 19 (only one illustrated in the drawings) is provided on the left and right sides of the body. A reference numeral 20 denotes an exhaust cooling duct in communication with one of the intake ducts 19. The exhaust cooling duct 20 cools the exhaust pipe 12 by taking in wind from the upside of the front of the front cowl 18, vertically piercing the rear through the upside of the fuel tank 9 and opening to the rear cowl 10. A reference numeral 21 denotes a wind intake. The wind intake 21 is provided on the left and right sides of the front of the rear cowl 10.

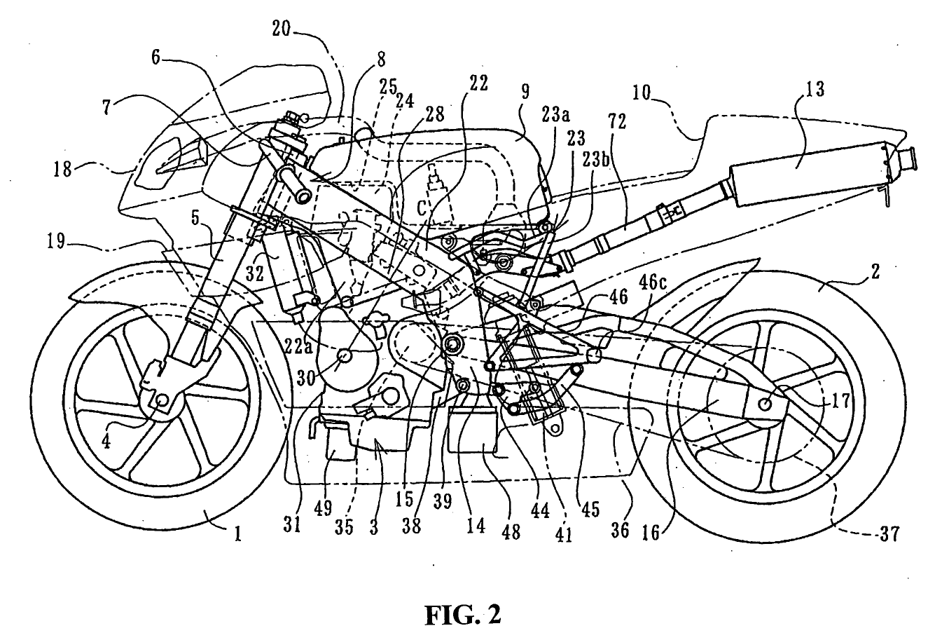

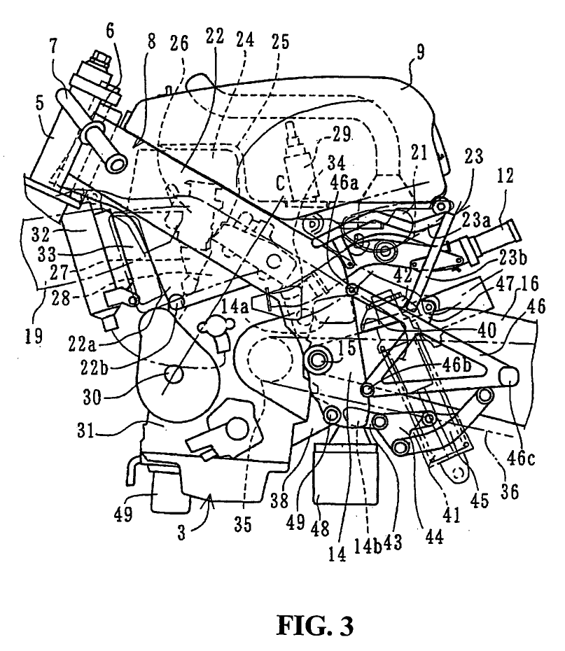

As shown in FIGS. 2 and 3, the body frame 8 is provided with a main frame 22 extended diagonally downward over the engine 3 and longitudinally from the upside of the engine 3. The pivot frame 14 is connected to the rear end of the main frame 22 and extends downward therefrom. A tank frame 23 is substantially triangular when the tank frame is viewed from the side. The tank frame 23 is also provided on the rear end of the main frame 22 so that the tank frame is convex upward from the main frame 22. The tank frame 23 supports the rear of the fuel tank 9.

The main frame 22 and the tank frame 23 are made of square metal pipe. The pivot frame 14 is made of a cast metal plate. The main frame 22, the tank frame 23 and the pivot frame 14 are provided in pairs on the left and right sides of the body frame 8. Left and right upper pipes 23a of the tank frame 23 are coupled at the rear end of the main frame 22. The left and the right pipes of the main frame 22 and the pivot frame 14 are coupled via cross pipes 14a, 14b shown in FIG. 3 and other figures.

An intake box 24 is arranged between the fronts of the left and the right pipes of the main frame 22 and at the back of the head pipe 6 in a state in which the intake box is housed in a concave portion 25 formed on the side of the bottom of the front of the fuel tank 9. The intake box 24 communicates with the left and right intake ducts 19 and takes in air, applying wind pressure on an electronic fuel injection system 26 provided inside.

An intake port 27 is connected to the electronic fuel injection system 26 and is extended substantially straightly upward from the front slope of a cylinder 28, which is inclined backward. The intake port 27 performs a downdraft-type intake. With regard to the cylinder 28, four parallel cylinders are arranged in a direction of the width of the body. The respective four pieces of the electronic fuel injection systems 26 and intake ports 27 are arranged in the direction of the width of the body by one every cylinder 28. Fuel is supplied to the electronic fuel injection system 26 from the downside of the bottom of the fuel tank 9 by a fuel pump 29 provided in the fuel tank 9.

The cylinder 28 is in a so-called state inclined backward in which the axis C is inclined diagonally upward and backward when the axis is viewed from the side in FIG. 3. A crankshaft 30 is located on a line extended downward of the axis C. The crankshaft 30 is located in the vicinity of the front end of a crankcase 31 and in front of the lower end of the cylinder 28. The intake box 24 is located on a vertical line passing the crankshaft 30. As shown in FIG. 3 in which the body is viewed from the side, the front end of the crankcase 31 and the front end of the intake box 24 are located in the substantially same position in a longitudinal direction. The intake box 24 is arranged in a substantially front position.

A radiator 32, which is a cooling part, is suspended backward and diagonally downward from the vicinity of the head pipe 6 of the main frame 22 and is supported in front of the cylinder 28. The lower end of the radiator 32 is supported by the upside of the front end of the crankcase 31 in the vicinity of the lower end of the cylinder 28. A substantially V-shaped space 33, when the space is viewed from the side, is formed between the radiator 32 and the cylinder 28. The intake box 24 is located above the space 33. The intake port 27 extends upward from the front of the cylinder 28 in the space 33 and is connected to the electronic fuel injection system 26.

The front end of the exhaust pipe 12 is connected to an exhaust port 34 provided on the rear of the cylinder 28. The exhaust pipe 12 extends backward and diagonally upward from the exhaust port 34 inside the rear cowl 10. A total four front pieces are provided on the exhaust pipe 12, one for every cylinder. The four front pieces are integrated into two halfway and are integrated into one further at the back. The one at the back is divided into left and right two again at the rear end and is connected to a pair of left and right mufflers 13 to be a 4-2-1-2 aggregation type. Each rear end of the left and right mufflers 13 protrudes backward from an opening provided at the rear end of the rear cowl 10.

An output sprocket 35 is provided on the rear of the engine 3 below the exhaust port 34 so that the output sprocket 35 drives a rear wheel sprocket 37 shown in FIG. 2 via a chain 36. The engine 3 is attached to a stay 22a extended downward from the downside of the main frame 22 at a coupling point 22b at the upper end on the front side of the crankcase 31. The engine 3 is also attached to a stay 38 extended from the downside of the rear of the crankcase 31 at the lower end of the pivot frame 14 at a coupling point 39.

The rear swing arm 16 is relatively long and is substantially in the shape of a trapezoid when it is viewed from the side. The rear swing arm is manufactured by casting of metal or other materials. In the front, left and right forked arms 40 are formed and are coupled to substantially the center in a vertical direction of the pivot frame 14 and the front end at the pivot point 15 so that the arms can be rocked. A rear cushion 41 is vertically arranged, inclining forward between the left and right arms 40. A bridge 42 installed between the left and right arms 40 supports the upper end.

The downside of the rear cushion 41 is coupled to the rear swing arm 16 via a substantially triangular first link 44 and a second link 45 coupled to the first link. The first link 44 is linked with a stay 43, which extends backward from the cross pipe 14b for coupling each lower part of the left and right pivot frames 14, by a shaft. The second link is in the shape of an arm.

Reference numeral 46 denotes a substantially triangular step bracket extended backward so that the step brackets cover both left and right sides of the front of the rear swing arm 16. The front ends are connected to an upper point and a lower point at the rear end of the pivot frame 14 at two vertical points 46a, 46b. Furthermore, a step 46c is attached to a rear end of the step bracket 46. A stay 47 protrudes upward on the upside of the step bracket 46. The lower end on the side of a lower side 23b of the tank frame 23 and the downside of the front end of the rear cowl 10 are attached to the stay.

A reference numeral 48 denotes a battery. The battery is suspended and supported from/by the lower end of the pivot frame 14 so as to lower the center of gravity of the body and converge mass. A reference numeral 49 denotes an oil filter. The oil filer protrudes downward from a position on the front side of the bottom of the crankcase 31.

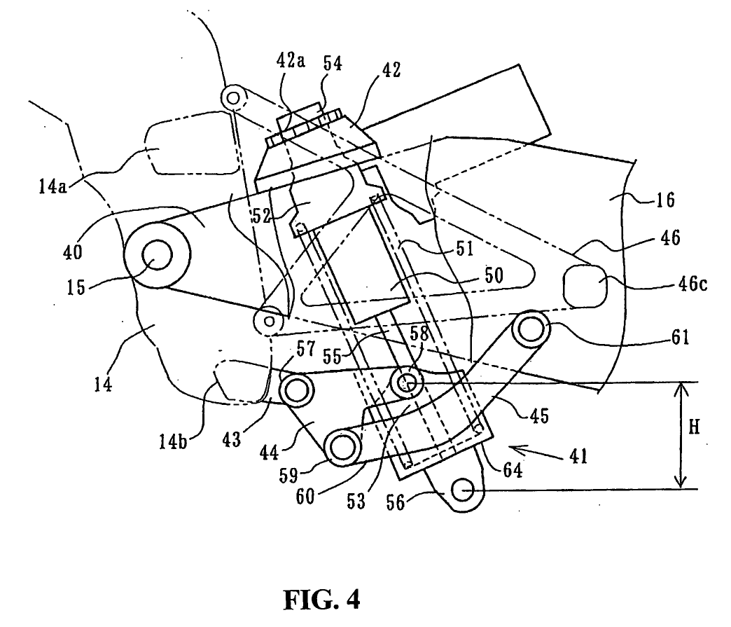

As shown in FIG. 4, the rear cushion 41, which is a shock absorber, is provided with a damper 50 and a cushion spring 51. The upper end of the cushion spring 51 is received by an upper retainer 52 attached to the side of the upside of the damper 50. A cushion holder 53 receives the lower end of the damper 50. A head 54 extends above the retainer 52 at the upper end of the damper 50. The head is fitted into a hole 42a of the bridge 42 and is prevented from moving upward by the retainer 52.

The cushion holder 53 is a cylindrical member having a bottom. The lower end of a piston rod 55 extending downward from the damper 50 and the lower end of the cushion spring 51 are supported inside the bottom. A part attached to the lower end 56 extends downward from the bottom of the cushion holder 53. This part is a part common to background art structures, which is not required in this embodiment. Therefore, although the part can be also omitted, it can be used for a rear suspension having a conventional type structure, and therefore can also be included.

The first link 44 is substantially triangular when it is viewed from the side and is linked with a stay 43 via a shaft at an intermediate vertex 57. The first link 44 is linked with the side of the cushion holder 53 via a shaft at an upper vertex 58 and is linked with the front end 60 of the second link 45 via a shaft at a lower vertex 59.

The second link 45 is in the shape of an arm and extends diagonally upward and backward when the second link is viewed from the side. The second link 45 is linked with the side of the rear swing arm 16 via a shaft at the rear end 61. A pair of left and right second links 45 is included.

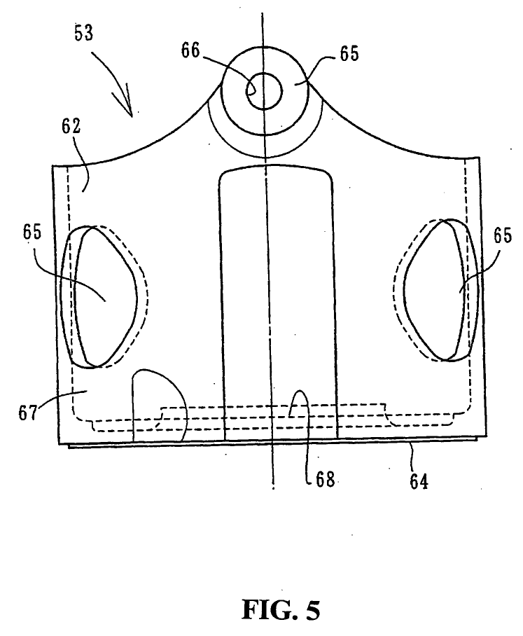

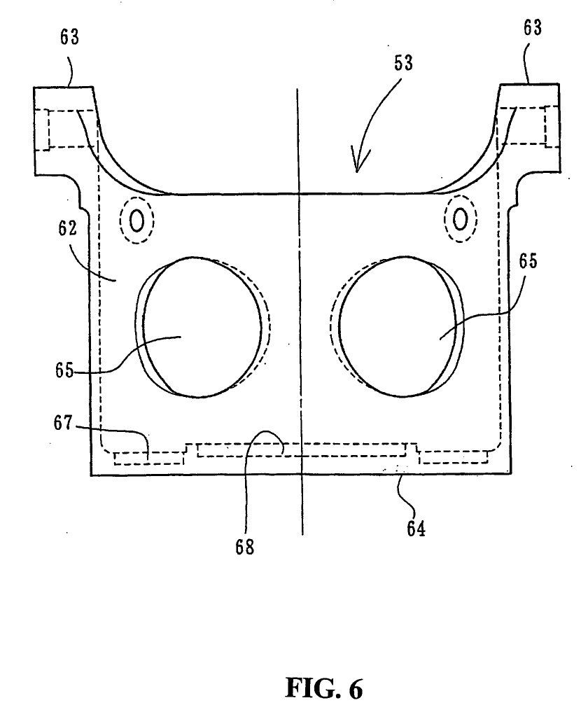

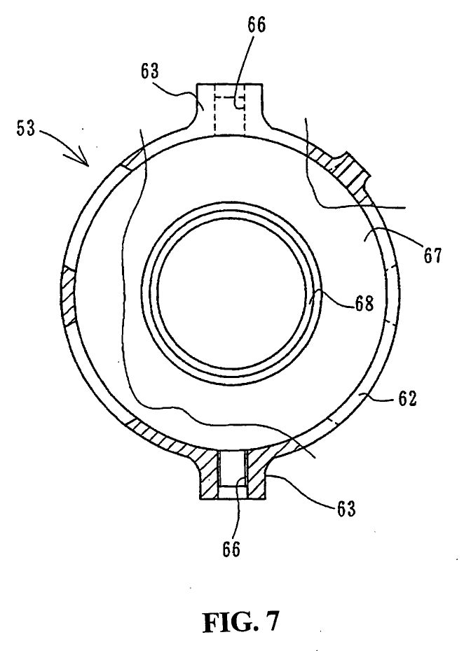

As shown in FIGS. 5 to 7, the cushion holder 53 is acquired by suitably casting metal material such as an aluminum alloy. A side peripheral wall 62, a boss 63 provided at the upper end thereof and the bottom 64 are integrated. The side peripheral wall 62 is a part housing a lower part of the cushion spring 51 inside and covering the side. Thinning holes 65 of an adequate number are formed on the periphery of the side peripheral wall 62.

The bosses 63 are formed as a pair of parts in the shape of an arm overhanging opposite positions at the upper end of the side peripheral wall 62. A nut hole 66 for linking the first link 44 via a shaft is formed at the end. A concave portion 67 for housing the lower end of the cushion spring 51 is provided on the periphery of the bottom 64 and a central concave portion 68 for receiving the lower end of the piston rod 55 is provided inside. The part attached to the lower end 56 protrudes below a hole formed in the center.

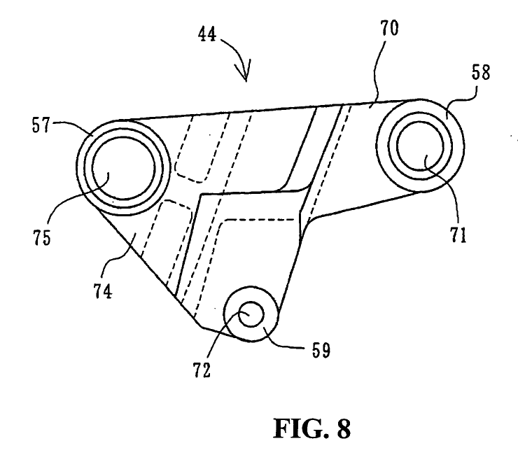

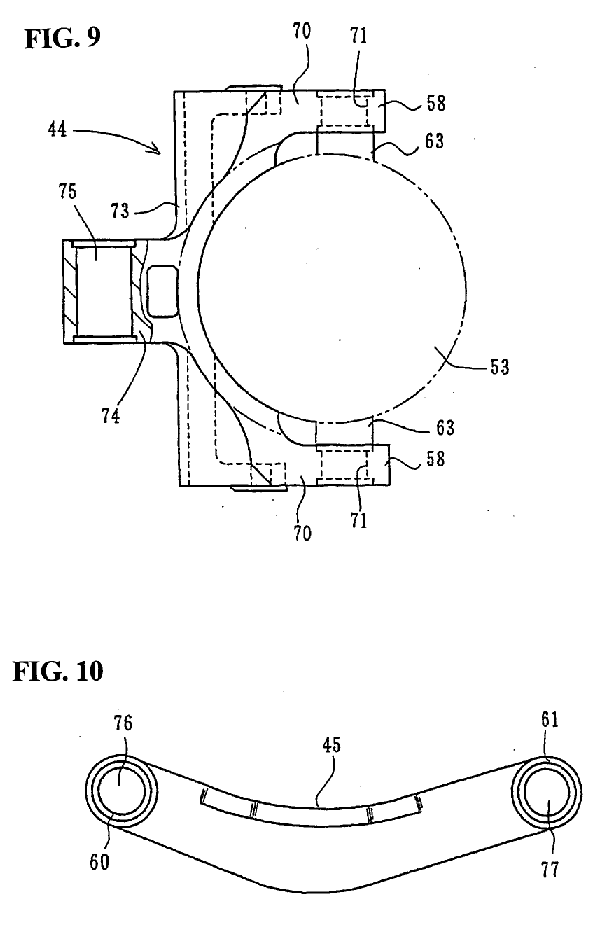

The first link 44 is formed using a light alloy such as an aluminum alloy and other suitable metal material by a suitable method such as casting and forging as shown in FIGS. 8 and 9. As is clear from FIG. 9, the upper vertex 58 is formed at each end of an arm 70 substantially U-shaped when the arm is viewed from the top so that the side of the cushion holder 53 is held between the vertexes and overhanged so that the forked sides of the cushion holder 53 are overlapped with the arm slightly longer than approximately ½. A hole for inserting a bolt 71 is formed at each end.

The lower vertex 59 is provided on a part protruded so that the part is overlapped with the side of the cushion holder 53 by approximately ¼ at the lower end viewed from the side of the first link 44. A hole for inserting a bearing 72 is formed so that the bearing (not shown) is inserted into the hole. A protruded part 74 coupling the left and right arms 70 and protruded forward from the center of the front 73 is provided in an overlapping manner with the front side of the cushion holder 53. The end functions as the part attached to the lower end 56 of the cushion holder 53 in a conventional arrangement. A hole for inserting a bearing 75 is formed in the protruded part 74.

The second link 45 is manufactured using similar materials and a similar method to those of the first link 44 as shown in FIG. 10. Holes for inserting bearings 76, 77 are formed at the front end 60 and at the rear end 61 of the second link 45. The hole for inserting the bearing 76 is made coincident with the hole for inserting the bearing 72 by overlapping it with the outside of the lower vertex 59 of the first link 44. The hole for inserting the bearing 76 is linked by a shaft member (not shown) so that the shaft member can be relatively turned. The hole for inserting the bearing 77 is overlapped with a boss formed on the side of the rear swing arm 16 from the outside. The hole for inserting the bearing 77 is made coincident with a nut hole thereof and is similarly linked via a shaft.

The action of this embodiment will now be described. When a load on the side of a road is input to the rear swing arm 16 from the rear wheel, the rear swing arm 16 is rocked upward with the pivot point 15 in the center. This rocking is transmitted from the second link 45 to the first link 44. Furthermore, the first link 44 is turned counterclockwise in FIG. 4 with a part linked via a shaft of the part attached to the lower end 56 in the center. Out of the cushion spring 51 and the piston rod 55, the respective lower ends of which are pressed by the cushion holder 53 to which the upper vertex 58 is coupled, the cushion spring 51 is compressed and a downward reaction force is increased. The piston rod 55 is then pushed upward in FIG. 4 and moves a piston (not shown) in the damper 50 upward and generates a damping force.

When no load is input from the rear wheel, the rear swing arm 16 is rocked in a reverse direction by the reaction force of the cushion spring 51 and is restored. At this time, since the first link 44 is coupled to the side of the cushion holder 53 at the upper vertex 58, the attached position is shifted upward by H, compared with the background art structure in which the first link is coupled to the part attached to the lower end 56. As a result, the position of the stay 43 that supports the first link 44 is also shifted upward. Furthermore, the positions of the lower vertex 59, which is a position coupled to the second link 45, and the front end 60 are also shifted upward. Therefore, a sufficient minimum road clearance can be secured.

In addition, the bottom 64 of the cushion holder 53 can be located below the upper vertex 58, although the upper vertex 58 is shifted to a higher position. Accordingly, the cushion spring 51 can be made long enough. In addition, since the piston rod 55 is not required to be shortened, the damper 50 is also not required to be shortened.

In addition, the bottom 64 that supports each lower end of the cushion holder 53 and the piston rod 55 is not related to the position of the upper vertex 58. Accordingly, they can be freely shifted downward within a range in which minimum road clearance can be secured. Therefore, it can be simultaneously realized to secure minimum road clearance and to sufficiently lengthen both the damper 50 and the cushion spring 51.

The present invention is not limited to the above-mentioned embodiment and can be variously transformed and applied within the principle of the present invention. For example, the arrangement of the cushion holder 53 in the rear cushion 41 can be vertically reversed. The cushion holder 53 can be provided on the side of the upper end of the rear cushion 41. The cushion holder 53 can be coupled to the side of the body frame via the link there and the side of the lower end of the rear cushion 41 may be also coupled to the lower part of the rear swing arm 16. In this case, the link does not protrude upward from the upper end of the rear cushion 41. Accordingly, the rear cushion 41 can be arranged in a high position.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A rear suspension, comprising:
a rear swing arm, a front end of the rear swing arm being coupled to a body frame so that the front end can be rocked and a rear end of the rear swing arm for supporting a rear wheel; and
a shock absorber, said shock absorber being provided between the rear swing arm and the body frame via a link, the shock absorber including a damper, a cushion spring and a cushion holder covering the outside of the cushion spring,
wherein one end of the link is coupled to a side of the cushion holder.

2. The rear suspension according to claim 1, wherein:
an upper end of the shock absorber is coupled to the rear swing arm, and
a lower end of the shock absorber is coupled to the body frame via the link.

3. The rear suspension according to claim 1, wherein the rear swing arm includes left and right forked arms, said left and right forked arms being pivotably coupled to a pivot frame attached to the body frame, the shock absorber is vertically arranged, inclining forward between the left and right forked arms, and a bridge is installed between the left and right forked arms to support an upper end of the shock absorber.

4. The rear suspension according to claim 1, wherein a lower end of the shock absorber is coupled to the rear swing arm via the link, the link including a substantially triangular first link and a second link coupled to the first link.

5. The rear suspension according to claim 4, wherein a first end of the first link is connected to a stay attached to the body frame, a second end of the first link is connected to the shock absorber and an intermediate portion of the first link is connected to a first end of the second link, a second end of the second link being connected to the rear swing arm.

6. The rear suspension according to claim 1, wherein the cushion holder is a cylindrical member having a bottom, a lower end of a piston rod extending downward from the damper and a lower end of the cushion spring being supported inside the bottom.

7. The rear suspension according to claim 1, wherein the cushion holder includes a pair of bosses on a side thereof, said bosses being coupled to the link, said cushion holder further including a connecting part extending downward from a bottom of the cushion holder.

8. The rear suspension according to claim 6, wherein the cushion holder includes a pair of bosses on a side thereof, said bosses being coupled to the link, said cushion holder further including a connecting part extending downward from the bottom of the cushion holder.

9. A rear suspension, comprising:
a rear swing arm, a front end of the rear swing arm being coupled to a body frame so that the front end can be rocked and a rear end of the rear swing arm for supporting a rear wheel; and
a shock absorber, said shock absorber being coupled between the rear swing arm and the body frame via a link, the shock absorber including a cushion holder at a lower end thereof,
wherein a first end of the link is coupled to a side of the cushion holder and a second end of the link is coupled to the body frame.

10. The rear suspension according to claim 9, wherein:
an upper end of the shock absorber is coupled to an upper side of the rear swing arm; and
a lower end of the shock absorber is coupled to the rear swing arm via the link.

11. The rear suspension according to claim 9, wherein the rear swing arm includes left and right forked arms, said left and right forked arms being pivotably coupled to a pivot frame attached to the body frame, the shock absorber is vertically arranged, inclining forward between the left and right forked arms, and a bridge is installed between the left and right forked arms to support an upper end of the shock absorber.

12. The rear suspension according to claim 9, wherein a lower end of the shock absorber is coupled to the rear swing arm via the link, the link including a substantially triangular first link and a second link coupled to the first link.

13. The rear suspension according to claim 12, wherein a first end of the first link is connected to a stay attached to the body frame, a second end of the first link is connected to the shock absorber and an intermediate portion of the first link is connected to a first end of the second link, a second end of the second link being connected to the rear swing arm.

14. The rear suspension according to claim 9, wherein the cushion holder is a cylindrical member having a bottom, a lower end of a piston rod extending downward from a damper of the shock absorber and a lower end of a cushion spring of the shock absorber being supported inside the bottom.

15. The rear suspension according to claim 9, wherein the cushion holder includes a pair of bosses on a side thereof, said bosses being coupled to the link, said cushion holder further including a connecting part extending downward from a bottom of the cushion holder.

16. The rear suspension according to claim 14, wherein the cushion holder includes a pair of bosses on a side thereof, said bosses being coupled to the link, said cushion holder further including a connecting part extending downward from the bottom of the cushion holder.
